(19) United States
(12) Patent Application Publication
(10) Pub. No.: US 2015/0066931 A1
(43) Pub. Date: Mar. 5, 2015

(54) INFORMATION PROCESSING APPARATUS AND METHOD

(71) Applicant: KABUSHIKI KAISHA TOSHIBA, Tokyo (JP)

(72) Inventors: Shinichi NAGANO, Yokohama (JP); Takahiro KAWAMURA, Tokyo (JP); Hirokazu SHIMADA, Tokyo (JP); Yoshiyuki MATSUDA, Chiba (JP); Yoshitaka KOBAYASHI, Kawasaki (JP)

(21) Appl. No.: 14/469,906

(22) Filed: Aug. 27, 2014

(30) Foreign Application Priority Data
Aug. 30, 2013 (JP) 2013-180699

(51) Int. Cl. G06F 17/30

(52) U.S. Cl. CPC G06F 17/30595; G06F 17/30241
USPC 707/737

(57) ABSTRACT

According to one embodiment, an information processing apparatus includes a collection unit, a storage and a retrieval unit. The collection unit collects first metadata from information sources, the first metadata relating to information that has no common standard between the information sources and including first attributes and first attribute values. The storage stores each of the first attributes and first attribute values corresponding to each of the first metadata. The retrieval unit retrieves the first metadata, based on corresponding relations of the first attributes and the first attribute values with second attributes and second attribute values in second metadata newly obtained, to extract corresponding metadata that is one of the first metadata and corresponds to the second metadata.

### CROSS-REFERENCE TO RELATED APPLICATIONS

This application is based upon and claims the benefit of priority from Japanese Patent Application No. 2013-180699, filed Aug. 30, 2013, the entire contents of which are incorporated herein by reference.

### FIELD

Embodiments described herein relate generally to an information processing apparatus and method.

### BACKGROUND

There is a demand for a status management system that collects information from a wide array of sources, such as government offices, municipalities, and citizens. For example, in case a disaster occurs, it is useful to collect information from a plurality of information sources and perform unified management of safety status information about citizens or the like; this is also true regarding the reliability of information. As a system of this kind, there is a technique that correlates geospatial information with information to be managed, and performs integrated management thereon.

### BRIEF DESCRIPTION OF THE DRAWINGS

FIG. 1 is a block diagram illustrating an information processing system including an information processing apparatus according to a first embodiment;

FIG. 2 is a view illustrating an example of metadata stored in a metadata storage;

FIG. 3 is a flow chart illustrating a retrieval process performed by a metadata retrieval unit according to the first embodiment;

FIG. 4 is a flow chart illustrating a retrieval process performed by a metadata retrieval unit according to a modification of the first embodiment;

FIG. 5 is a view illustrating an example of a case of performing association with a lost attribute value;

FIG. 6 is a block diagram illustrating an information processing system including an information processing apparatus according to a second embodiment;

FIG. 7 is a flow chart illustrating a retrieval process performed by a metadata retrieval unit according to the second embodiment;

FIG. 8 is a view illustrating a specific example of the retrieval process performed by the metadata retrieval unit according to the second embodiment;

FIG. 9 is a block diagram illustrating an information processing system including an information processing apparatus according to a third embodiment; and

FIG. 10 is a flow chart illustrating a process performed by a metadata retrieval unit and an importance calculation unit according to the third embodiment.

### DETAILED DESCRIPTION

In the technique described above, when integrating a plurality of pieces of regional information and disaster prevention information from different competent authorities, in order to perform integrated management standardization, it is essential to integrate data as well as to correlate management target information with geospatial information. Thus, this technique often limits the information sources from which data is to be collected, therefore it cannot, for example, ascertain the status of regions outside the jurisdiction of a given municipality.

In general, according to one embodiment, an information processing apparatus includes a collection unit, a storage and a retrieval unit. The collection unit is configured to collect pieces of first metadata from a plurality of information sources, each piece of first metadata relating to information that has no common standard of data model or format to be exchanged between the plurality of information sources and including first attributes and first attribute values, the first attributes indicating item names included in the piece of first metadata, the first attribute values corresponding to the first attributes. The storage is configured to store each of the first attributes and first attribute values corresponding to each of the pieces of first metadata. The retrieval unit is configured to newly obtain a piece of second metadata including second attributes and second attribute values, and retrieve the pieces of first metadata, based on corresponding relations of the first attributes and the first attribute values with the second attributes and the second attribute values, to extract corresponding metadata that is one of the pieces of first metadata and corresponds to the piece of second metadata, the second attributes indicating item names in the piece of second metadata, the second attribute values corresponding to the second attributes.

In the following, the information processing apparatus and method according to an embodiment of the present disclosure will be explained with reference to the drawings. In the following embodiments, the explanation of the elements with the same reference numerals will be omitted for brevity as their operations will be the same.

### First Embodiment

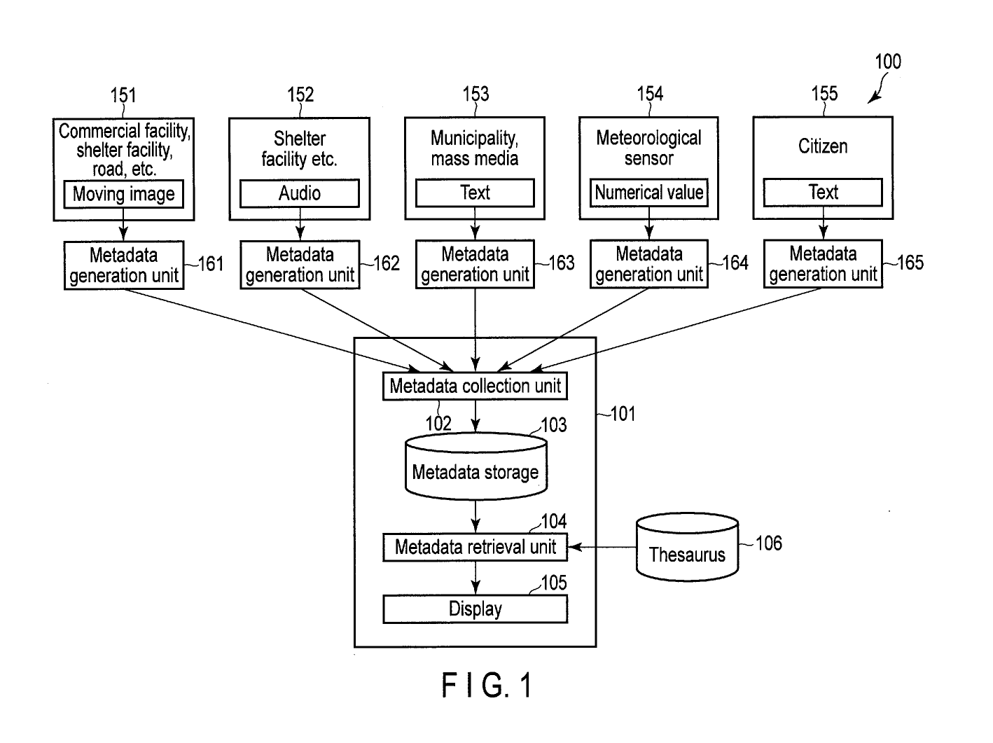

An information processing system including an information processing apparatus according to the first embodiment will be explained with reference to the block diagram shown in FIG. 1. In this embodiment, collection of information in the case of a disaster will be explained as an example. However, the present embodiments are not limited to this example, but can be applied to any event. For example, the present embodiments can be similarly applied to information about fireworks festivals planned by municipalities, lecture meetings, or bargain days of commercial facilities, etc.; or information about transportation systems, such as train operation status or road congestion conditions.

The information processing system 100 according to the first embodiment includes information sources 151, 152, 153, 154, and 155, metadata generation units 161, 162, 163, 164, and 165, an information processing apparatus 101, and a thesaurus 106. The information processing apparatus 101 includes a metadata collection unit 102, a metadata storage 103, a metadata retrieval unit 104, and a display 105.

The information source 151 is, for example, a fixed-point camera installed at commercial facilities, shelter facilities, and/or roads, that generates moving images.

The information source 152 is, for example, a microphone installed at public facilities and/or shelter facilities that generates audio signals of users when the users speak toward the microphone.

The information source 153 is, for example, a disaster announcement and/or official announcement from municipalities and/or mass media, and text data of information that is generated and transmitted from the municipalities and/or media through an Internet capable network, or the like. It should be noted that audio signals may also be generated from announcements made by voice, such as an official interview.

The information source 154 is, for example, meteorological sensors that generate numerical values representing information concerning weather, such as temperature, humidity, and wind velocity.

The information source 155 is, for example, common citizens (who are called general users, as well) who utilize SNSs (social networking services), and who generate text data about disaster information contributed by general users through SNSs. Moving images and/or audio signals may also be obtained from information transmitted by video and/or voice from general users.

The metadata generation unit 161 generates, when receiving a camera image (still picture or motion picture) from the information source 151, metadata including an identifier (ID) of the camera which acquired the camera image, time information concerning the time when the camera image was acquired, and geolocation information concerning the where the camera was located, and to then associate the metadata with the camera image. The metadata generation unit 161 may utilize an object recognition technique to recognize persons, objects such as buildings and automobiles, and/or disaster phenomena such as fire and smoke shown in the camera image, and then make the names of the thus-recognized objects included in the metadata. The metadata generation unit 161 may further utilize a service that provides facial images registered therein, such as an SNS, to collate a facial image of a recognized person with a registered profile image, and then make the full name of this person included in the metadata. The metadata generation unit 161 may further utilize an optical character recognition (OCR) technique to recognize character images shown in the camera image and extract a text, and to then make this text included in the metadata.

The metadata generation unit 162 generates, when receiving an audio signal from the information source 152, metadata including an identifier (ID) of the microphone which acquired the audio signal, time information concerning the time when the audio signal was acquired, and geolocation information concerning where the microphone was located, and then associates the metadata with the audio signal. The metadata generation unit 162 may further utilize a speech recognition technique to convert the audio signal into a text, and then make this text included in the metadata. The metadata generation unit 162 may further utilize a natural language processing technique to extract proper representations (named entities) such as a personal name and geographical name from the text, and then make the proper representations included in the metadata.

The metadata generation unit 163 generates, when receiving text data from the information source 153, metadata including an identifier (ID) of the municipality or media which announced the text data, time information concerning the time when the text data was announced, and geolocation information concerning the seat of the municipality or media, and then associates the metadata with the text data. The metadata generation unit 163 may further utilize a natural language processing technique to extract proper representations, such as a personal name and geographical name, from the text data, and then make the proper representations included in the metadata.

The metadata generation unit 164 generates, when receiving a numerical value observed on an observation subject from the information source 154, metadata including an identifier (ID) representing the observation object, time information concerning the time when the numerical value was obtained, and geolocation information concerning the region to which the information relates, and then associates the metadata with the numerical value.

The metadata generation unit 165 generates, when receiving text data from the information source 155, metadata including an ID of the user who created the text data, and time information concerning the time when the text data was created, and then associates the metadata with the text data. The metadata generation unit 165 may further utilize a natural language processing technique to extract proper representations, such as a personal name and geographical name, from the text data, and then make the proper representations included in the metadata. The metadata generation unit 165 may further pay attention to the grammatical units of speech of words included in the text data to interpret the intention of the user who created the text data, for example, a request, such as, “I want to know . . . ” or, “I want (some item) . . . ”, and/or an inquiry, such as, “Where is the evacuation shelter?”, or “Are the trains operating?”, and then to make the interpreted content included in the metadata. In this respect, it is preferable that the information source 155 does not necessarily require geolocation information concerning the location where the text data was created, from the viewpoint of privacy protection of general users.

The information sources 151, 152, 153, 154, and 155 may respectively include the metadata generation units 161, 162, 163, 164, and 165. The processes performed by the metadata generation units can be realized by use of general processes.

The metadata collection unit 102 collects pieces of metadata respectively from the metadata generation units 161, 162, 163, 164, and 165. The interval of times to collect pieces of metadata may be set to collect them at regular time intervals, or may be set to collect them every time new metadata is generated by each information source. The metadata collection unit 102 may further collect, when collecting a piece of metadata, a moving image, audio signal, numerical value, and text data that correspond to this metadata.

The metadata storage 103 receives metadata from the metadata collection unit 102 and to then store it. If the metadata collection unit 102 collects a moving image, audio signal, numerical value, and text data that correspond to the metadata, the metadata storage 103 may store them along with the metadata. The moving image, audio signal, numerical value, and text data may be stored in an external storage (not shown), and correlated with the corresponding metadata stored in the metadata storage 103.

In relation to newly stored metadata, the metadata retrieval unit 104 retrieves a piece of metadata corresponding thereto from pieces of metadata stored in the metadata storage 103, and then extracts the metadata corresponding thereto as corresponding metadata. The retrieval process of metadata may be performed at regular time intervals or may be performed every time metadata is newly stored. The retrieval process performed by the metadata retrieval unit 104 will be explained later with reference to a specific example.

The display 105 receives the corresponding metadata from the metadata retrieval unit 104, and then displays the corresponding metadata, retrieved as described above, on a display, for example.

The thesaurus 106 stores similar words and synonyms, and presents similar words and synonyms in response to requests from the metadata retrieval unit 104.

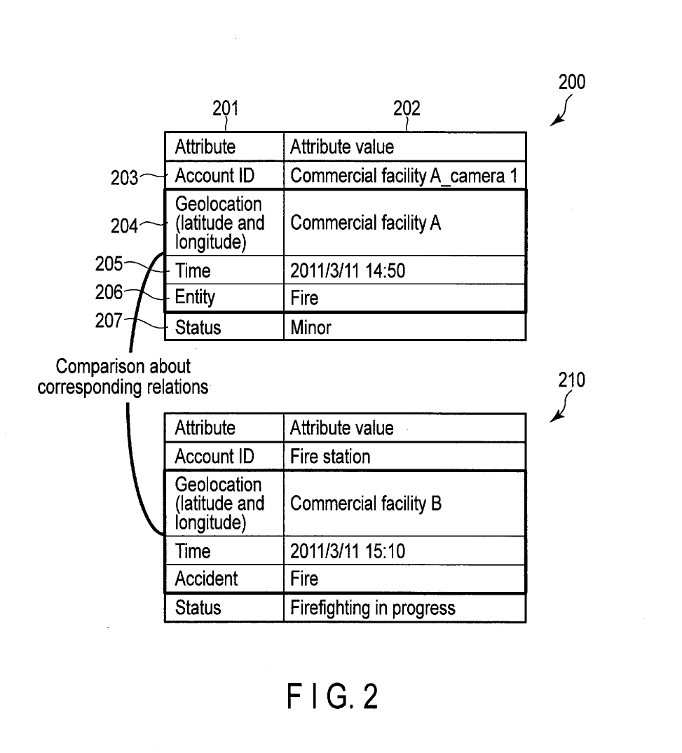

Next, an example of metadata stored in the metadata storage 103 will be explained with reference to FIG. 2. FIG. 2 illustrates an example of metadata generated from a moving image acquired by a camera installed at a commercial facility.

Metadata 200 includes attributes 201 and attribute values 202, which are associated with each other and stored in the metadata storage 103 for each piece of metadata 200. The attributes 201 are item names used in the metadata, and the attribute values 202 are values and/or states corresponding to the attributes 201. In the example shown in FIG. 2, the attributes 201 include an account ID 203, geolocation information 204, time information 205, entity 206, and status 207.

The account ID 203 indicates an identifier in a facility to which it belongs, or an identifier representing an account in an SNS or the like. This example shows an ID of a camera installed at a facility, wherein “account ID” serving as an attribute 201 and “commercial facility A_camera 1” serving as an attribute value 202 are associated with each other.

The geolocation information 204 indicates geolocation information about an information source and geolocation information about a person or facility serving as the center of a topic transmitted from the information source. This example shows information about the location where the camera 1 is installed. The geolocation information may include degrees of latitude and longitude.

The time information 205 indicates time when the information was obtained. This example stores, as an attribute value 202, the time when the camera acquired the information.

The entity 206 indicates what kind of event occurred.

The status 207 indicates the status of the entity 206.

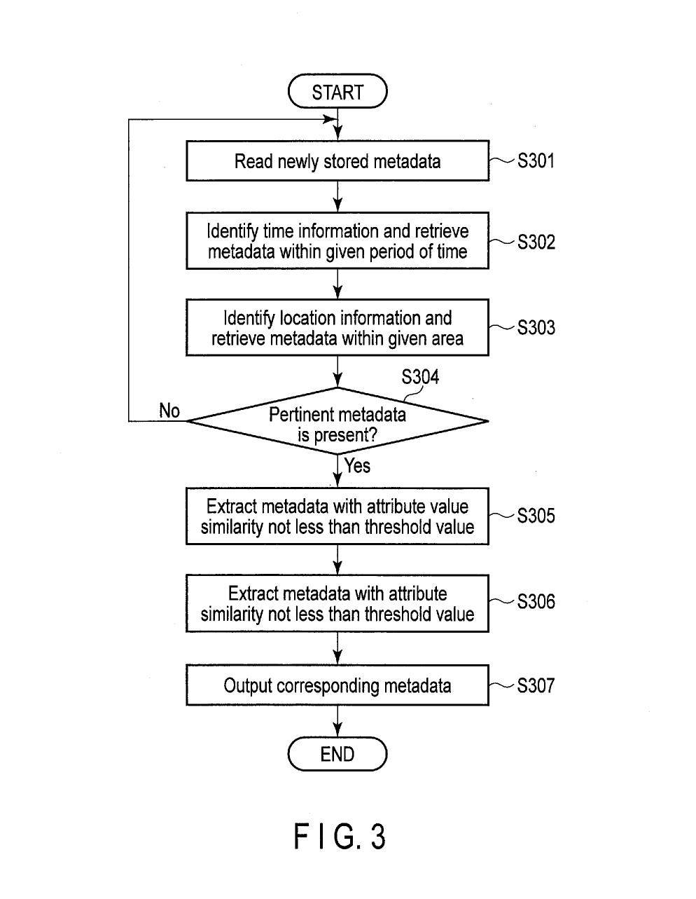

Next, a retrieval process performed by the metadata retrieval unit 104 according to the first embodiment will be explained with reference to the flow chart shown in FIG. 3.

In step S301, the metadata retrieval unit 104 reads metadata newly stored in the metadata storage 103.

In step S302, the metadata retrieval unit 104 identifies time information from the attributes and attribute values included in the metadata, and retrieves, from the metadata storage 103, metadata including an attribute value of time information, which falls within a given period of time.

In step S303, the metadata retrieval unit 104 identifies geolocation information from the attributes and attribute values included in the metadata, and retrieves metadata from the metadata storage 103, including an attribute value of geolocation information, which falls within a given area.

In step S304, the metadata retrieval unit 104 determines whether pertinent metadata is present based on the step S302 and the step S303. If pertinent metadata is present, the process proceeds to step S305. If pertinent metadata is not present, the process returns to step S301, and repeats the same processes.

In step S305, the metadata retrieval unit 104 identifies metadata from pieces of pertinent metadata, which includes an attribute that agrees with an attribute of the newly stored metadata, and then calculates the similarity of the corresponding attribute value. In a case where pieces of metadata are generated respectively from information sources that do not have a common standard between them, item names listed as the attributes 201 may be different from each other among the information sources. The “common standard” mentioned above means a standard that prescribes names of the attributes and the type and range of values taken as the attribute values, which can be included in metadata. It is assumed that the format for expressing metadata is unified. An example of such a data format is CSV (Comma Separated Value, comma separated text data), JSON (Java (registered trademark) Script Object Notation), or Linked Dat. In this case, it suffices if metadata is extracted based on the similarity of the attribute values not less than a threshold value. In order to determine whether or not the similarity is not less than a threshold value, it can, for example, calculate the edit distance and/or cosine similarity of character strings used for indicating the respective attribute values, and/or it can find out similar words by use of a thesaurus.

In step S306, the metadata retrieval unit 104 identifies metadata from pieces of pertinent metadata, which includes an attribute value that agrees with an attribute value of the newly stored metadata, and then calculates the similarity of the corresponding attribute and extracts metadata with similarity not less than a threshold value. More specifically, for example, in a case where “time”, “date information”, and “Time” are present as attributes, they are similar words because they indicate time, and so it can be determined that the similarity of these attributes is not less than a threshold value.

In step S307, the metadata retrieval unit 104 outputs the thus extracted metadata as corresponding metadata. In this way, the metadata retrieval unit 104 ends the retrieval process. It should be noted that it may perform only one of either step S305 or step S306 to determine the similarity of an attribute or attribute value.

A specific example about the similarity determination is explained with reference to FIG. 2 described above.

In FIG. 2, when the attributes 201 of the metadata 200 are compared with the attributes 201 of metadata 210, their attributes match each other in the geolocation information 204 and the time information 205, but their attributes do not match each other in the entity 206 and the disaster. In this case, “fire” shown as an attribute value 202 corresponding to the entity 206 matches to “fire” shown as an attribute value 202 corresponding to the disaster, and so the similarity between the entity and the disaster can be determined as being not less than a threshold value. In this case, it is possible to extract the metadata 210 as corresponding metadata in relation to the metadata 200.

### Modification of First Embodiment

Among the collected pieces of metadata, there may be metadata with its attribute values partly lost, in other words with its values partly not included. Even in such a case, corresponding metadata can be obtained with reference to some of the attributes and attribute values.

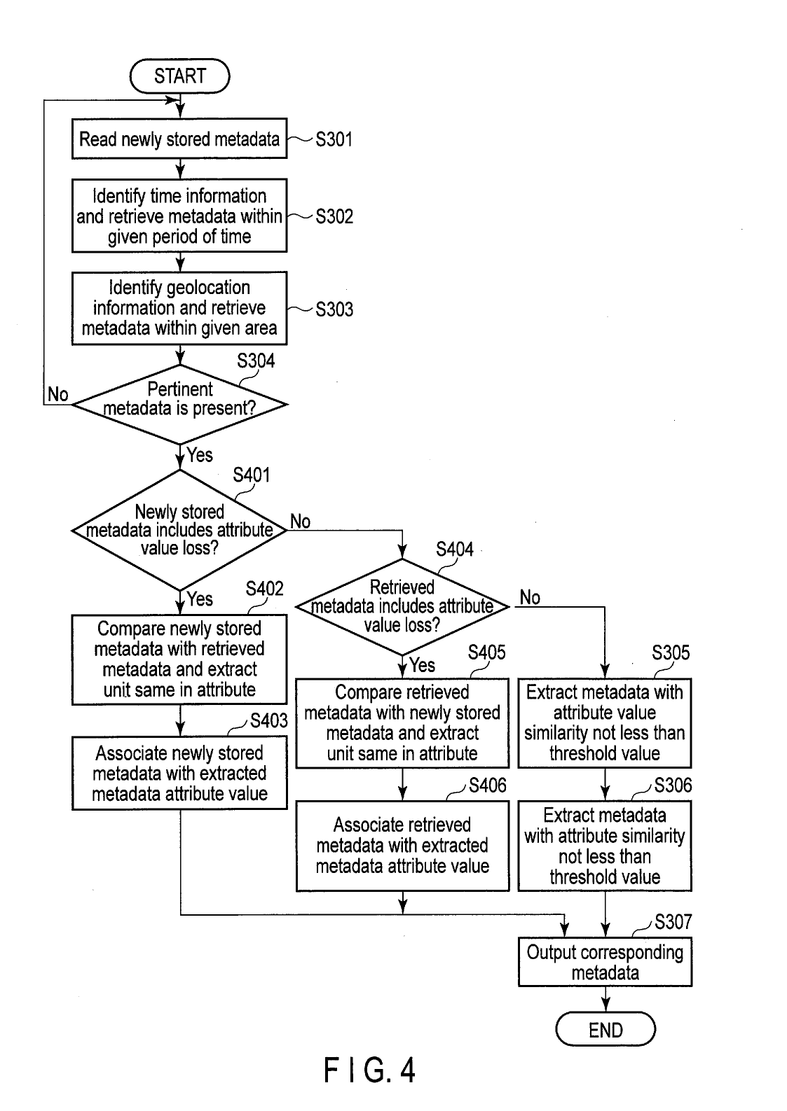

An operation of the metadata retrieval unit 104 according to a modification of the first embodiment will be explained with reference to the flow chart shown in FIG. 4. In this respect, the processes in the steps of S301 to S307 are the same as those in FIG. 3, and so their descriptions are omitted.

In step S401, the metadata retrieval unit 104 determines whether or not the newly stored metadata includes a loss of the attribute values. If there is a loss of the attribute values included, the process proceeds to step S402. If there is no loss of the attribute values included, the process proceeds to step S404.

In step S402, the metadata retrieval unit 104 compares the newly stored metadata with the pertinent metadata found in step S304, and extracts an attribute from the pertinent metadata found in step S304, which corresponds to the lost attribute value of the newly stored metadata.

In step S403, the metadata retrieval unit 104 associates the lost attribute value with the attribute value of the metadata extracted in step S402.

In step S404, the metadata retrieval unit 104 determines whether or not the retrieved metadata includes a loss of the attribute values. If there is a loss of the attribute values included, the process proceeds to step S405. If there is no loss of the attribute values included, the process proceeds to step S305, and repeats the same processes.

In step S405, the metadata retrieval unit 104 compares the retrieved metadata with the newly stored metadata, and extracts an attribute from the newly stored metadata, which corresponds to the lost attribute value of the retrieved metadata.

In step S406, the metadata retrieval unit 104 associates the lost attribute value with the attribute value of the metadata extracted in step S405. In this way, the metadata retrieval unit 104 ends the operation of extracting an attribute value.

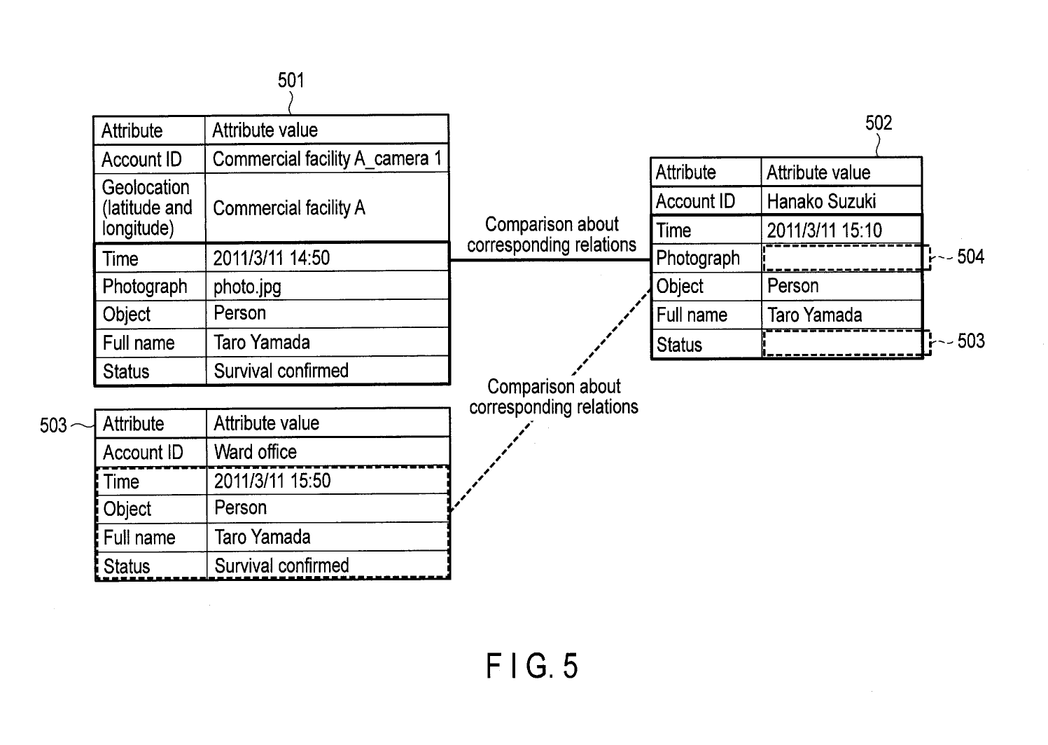

Next, a specific example of a case of performing association with a lost attribute value is explained with reference to FIG. 5.

FIG. 5 shows a case where it is assumed that pieces of metadata 501, 502, and 503 are stored in the metadata storage 103 in this order, and that the attribute values of the metadata 502 are partly lost. The pieces of metadata 501, 502, and 503 are assumed as follows: The metadata 501 is metadata generated from a camera image obtained by a fixed-point camera, wherein a person “Taro Yamada” is recognized by use of an object recognition technique. The metadata 502 is metadata generated from a transmission of a general user on an SNS. The metadata 503 is metadata generated from an audio signal obtained at a shelter facility or text data uploaded on an Internet capable network, by use of a voice recognition technique or a natural language processing technique.

More specifically, the metadata 502 includes a loss at an attribute value 504 corresponding to an attribute “photograph” and a loss at an attribute value 505 corresponding to an attribute “status”. In other words, this metadata 502 is an example of metadata generated by use of a language processing technique in a case where Hanako Suzuki transmits information, such as “I want to know the status of Taro Yamada.”

When the corresponding relations are compared with each other in accordance with step S402 and step S403 in FIG. 4, there is a match in the full name “Taro Yamada”. Consequently, the image associated with the metadata 501 can be determined as being that of Taro Yamada, and thus it can provide information about his survival confirmed at a time point defined by the time of “2011/3/11 14:50”.

Thereafter, when the metadata 503 is newly stored, it is compared with the metadata 502, which includes the losses of the attribute values, about the corresponding relations in accordance with the step S405 and step S406. At this time, there is an match in the full name “Taro Yamada”, and an match between the deficient attribute “status” of the metadata 502 and the attribute “status” of the metadata 503, and so the attribute value “survival confirmed” of the metadata 503 can be associated with the lost attribute value. Consequently, it is possible to extract information about the survival of Taro Yamada as new information. In this way, for example, when searching for a person, it is possible to reliably retrieve previous information and/or the latest information about this person.

According to the first embodiment described above, even when pieces of metadata which are not standardized are collected from a plurality of information sources, their information can be suitably managed and retrieved by use of a determination based on the similarity of the attributes and attribute values included in the pieces of metadata. Furthermore, even when some of the information is lost, the information can be compensated for by use of another piece of metadata, and so it is possible to retrieve necessary information from a large variety of data to obtain information with higher accuracy.

### Second Embodiment

The second embodiment differs in that retrieval of metadata is performed with reference to the interest relationship (a ‘follow’ relationship, such as when using SNS to ‘follow’ a particular SNS user or site) between a plurality of information sources.

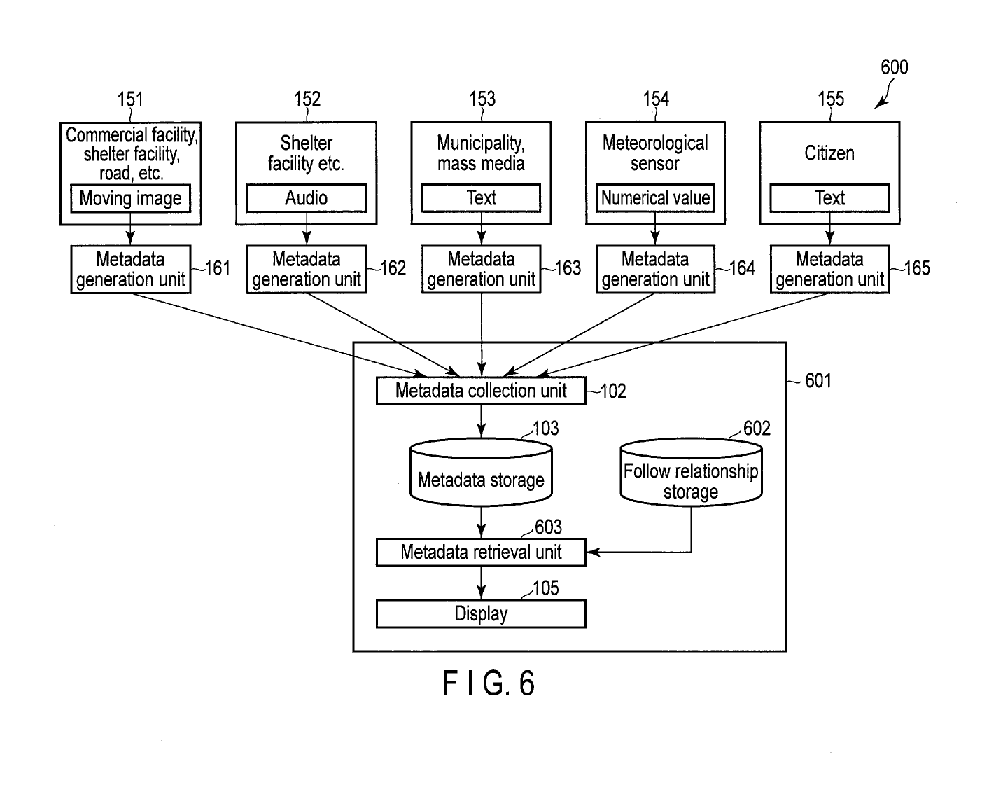

An information processing system including an information processing apparatus according to the second embodiment will be explained with reference to the block diagram shown in FIG. 6.

The information processing system 600 according to the second embodiment includes information sources 151, 152, 153, 154, and 155, metadata generation units 161, 162, 163, 164, and 165, and an information processing apparatus 601. The information processing apparatus 601 includes a metadata collection unit 102, a metadata storage 103, a display 105, a follow relationship storage 602, and a metadata retrieval unit 603.

The members other than the follow relationship storage 602 and the metadata retrieval unit 603 are the same as those of the first embodiment, and so their descriptions are omitted here.

The follow relationship storage 602 stores the follow relationships between a plurality of information sources. Regarding the follow relationships, for example, it may be set to personify a plurality of information sources, and to store such follow relationships in an SNS, which show whether or not they respectively have IDs in the SNS and they are interested in each other. More specifically, when a certain citizen is interested in video images acquired by a camera installed at a commercial facility A (a so-called ‘live’ camera or the like), and is also interested in information transmitted from a certain municipality, follow relationships can be formed between them. In this respect, follow relationships have directional characteristics such that, in this example, a certain citizen who is a follower forms the follow relationship respectively to the video images acquired by the camera of the commercial facility A and the municipality, which are the entities being followed. The follow relationship storage 602 may be configured to reference an external database about follow relationships.

The metadata retrieval unit 603 is almost the same as the metadata retrieval unit 104, but differs in that it performs retrieval of corresponding metadata with reference to the follow relationships stored in the follow relationship storage 602.

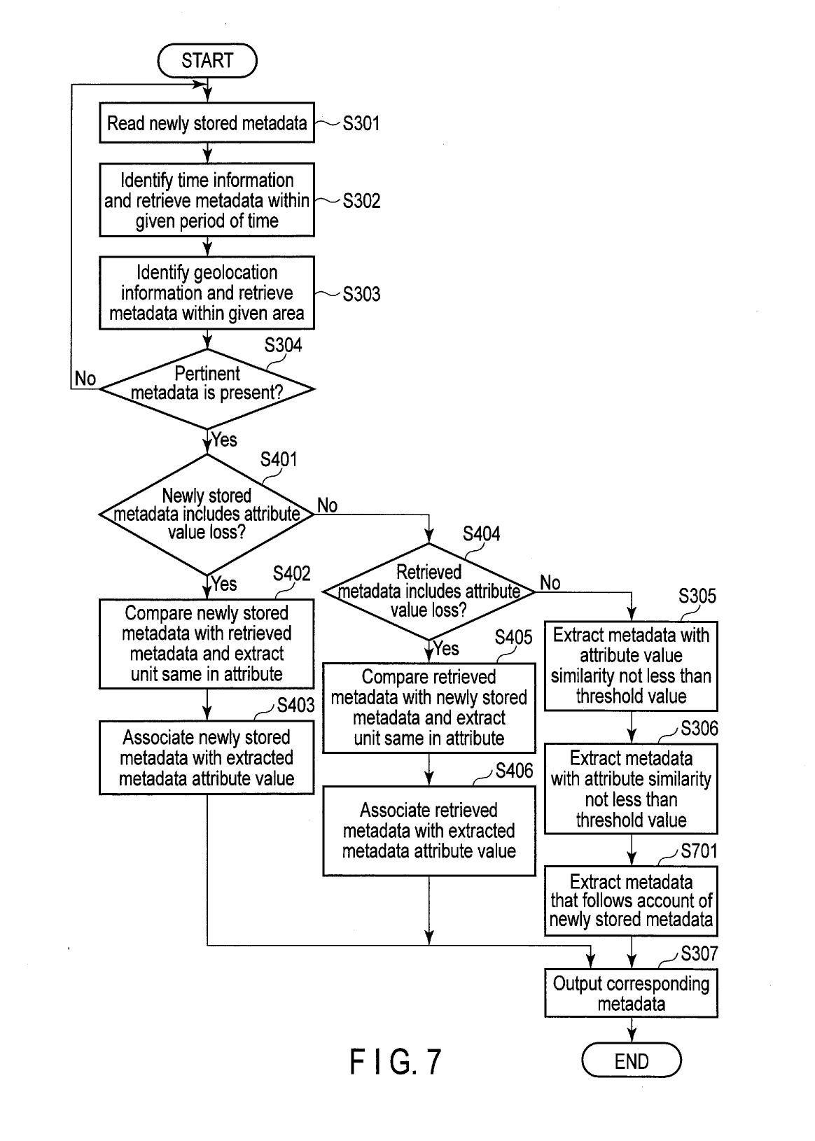

Next, an explanation will be given of a retrieval process performed by the metadata retrieval unit 603 according to the second embodiment, with reference to the flow chart shown in FIG. 7.

The processes in the steps of S301 to S307 and the processes in the steps of S401 to S406 are the same as those in the flow chart shown in FIG. 4, and so their descriptions are omitted here.

Step S701 references the follow relationship storage 602 in terms of the follow relationships between their respective account IDs in relation to the extracted pieces of corresponding metadata, and preferentially extracts from them metadata with an account ID that follows the account ID of the newly stored metadata.

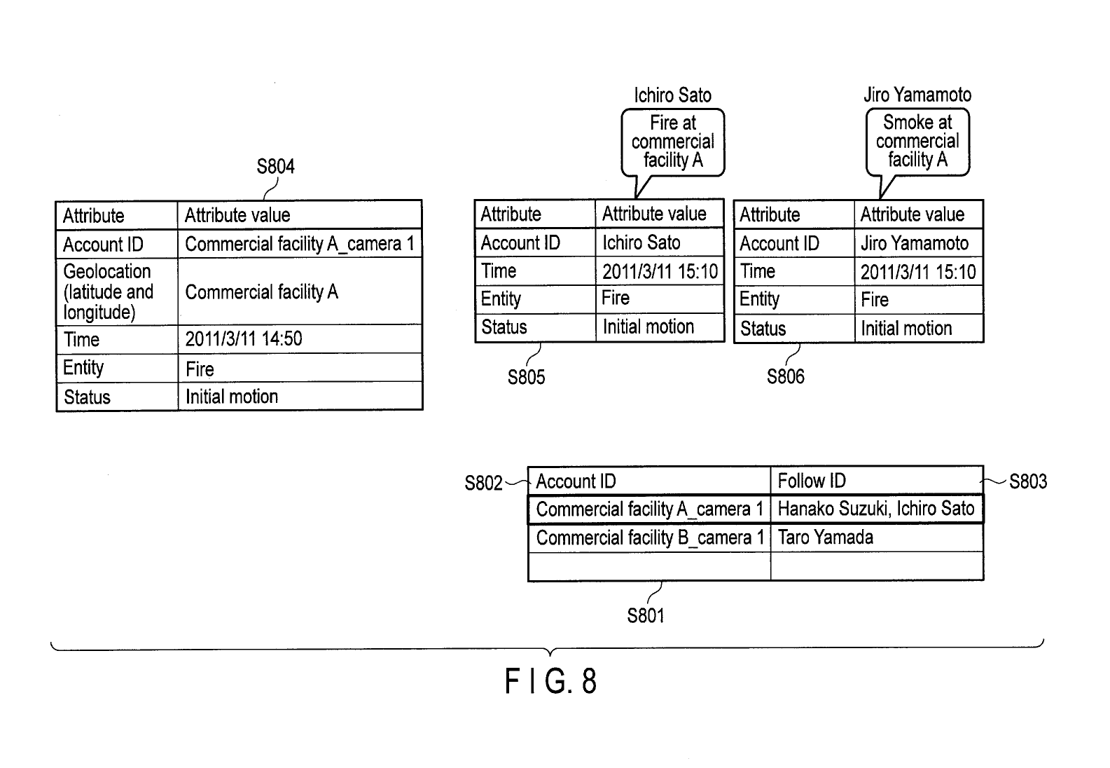

Next, an explanation will be given of a specific example of a retrieval process of corresponding metadata by use of a follow relationship, with reference to FIG. 8.

As shown in FIG. 8, a follow relationship 801 includes an account ID 802 and a follow ID 803 associated with each other. The account ID 802 is the same as the account ID included in metadata. The follow ID 803 indicates an ID that follows the account ID 802, wherein a personal name is used for the follow ID.

The example shown in FIG. 8 is assumed as follows: Metadata 804 is obtained from a moving image about a fire acquired by a fixed point camera A installed at a commercial facility A. Metadata 805 is obtained from an online post “fire at commercial facility A” made on an SNS by a citizen, Ichiro Sato. The term “online post” indicates a text massage that is sent to SNS. In addition, metadata 806 is obtained from a post “smoke at commercial facility A” made on an SNS by Jiro Yamamoto.

In this case, as shown in the follow relationship 801, Ichiro Sato follows the fixed-point camera of the commercial facility A, but Jiro Yamamoto does not follow the fixed-point camera of the commercial facility A. It can be thought that Ichiro Sato, who follows the fixed-point camera of the commercial facility A, is more interested in the fixed-point camera of the commercial facility A than Jiro Yamamoto, who does not follow the fixed-point camera of the commercial facility A. Accordingly, the posts made by Ichiro Sato is regarded as more accurately reflecting the status of the site than the posts made by Jiro Yamamoto, and so the metadata 805 is preferentially extracted as corresponding metadata.

According to the second embodiment described above, it is possible to extract the metadata of information sources with higher reliability by referencing the follow relationships.

### Third Embodiment

The third embodiment differs in that the importance of corresponding metadata is determined with reference to the follow relationships.

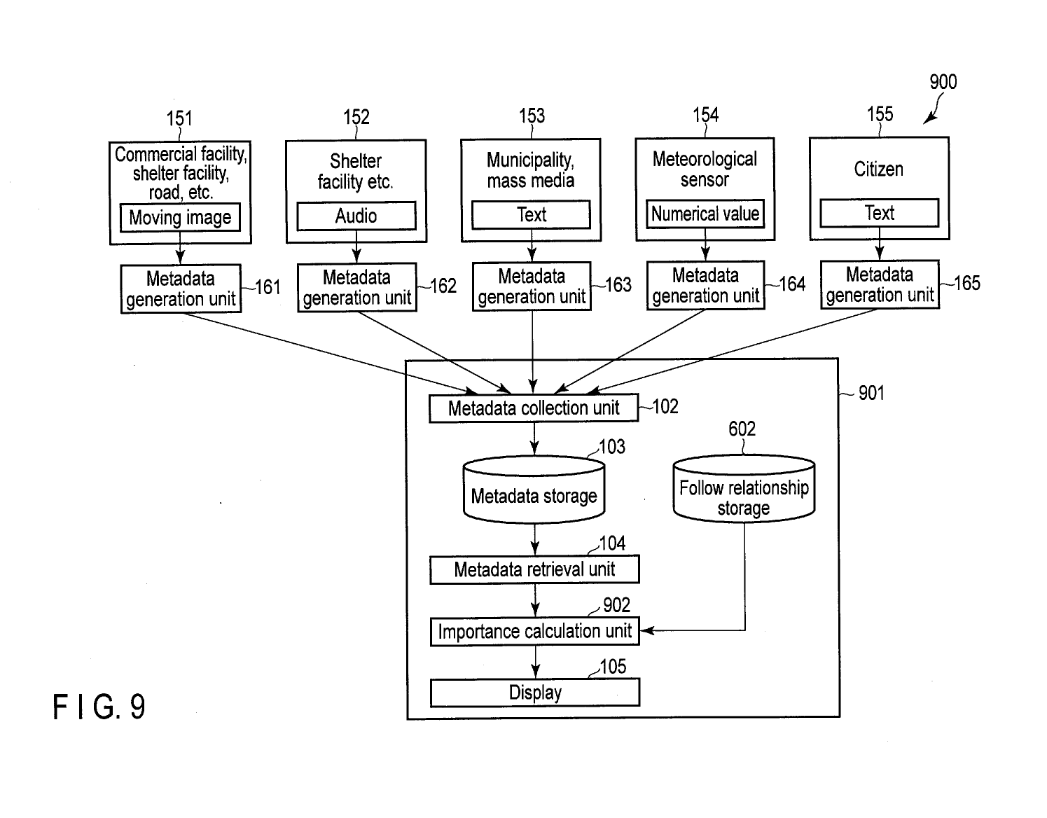

An explanation will be given of an information processing system including an information processing apparatus according to the third embodiment, with reference to the block diagram shown in FIG. 9.

The information processing system 900 according to the third embodiment includes information sources 151, 152, 153, 154, and 155, metadata generation units 161, 162, 163, 164, and 165, and an information processing apparatus 901. The information processing apparatus 901 includes a metadata collection unit 102, a metadata storage 103, a display 105, a metadata retrieval unit 104, a follow relationship storage 602, and an importance calculation unit 902. As in the second embodiment, it may reference external follow relationships, without including the follow relationship storage 602.

The members other than the importance calculation unit 902 are the same as those of the first embodiment, and so their descriptions are omitted here.

The importance calculation unit 902 calculates the importance of each piece of corresponding metadata with reference to the follow relationships stored in the follow relation storage 602.

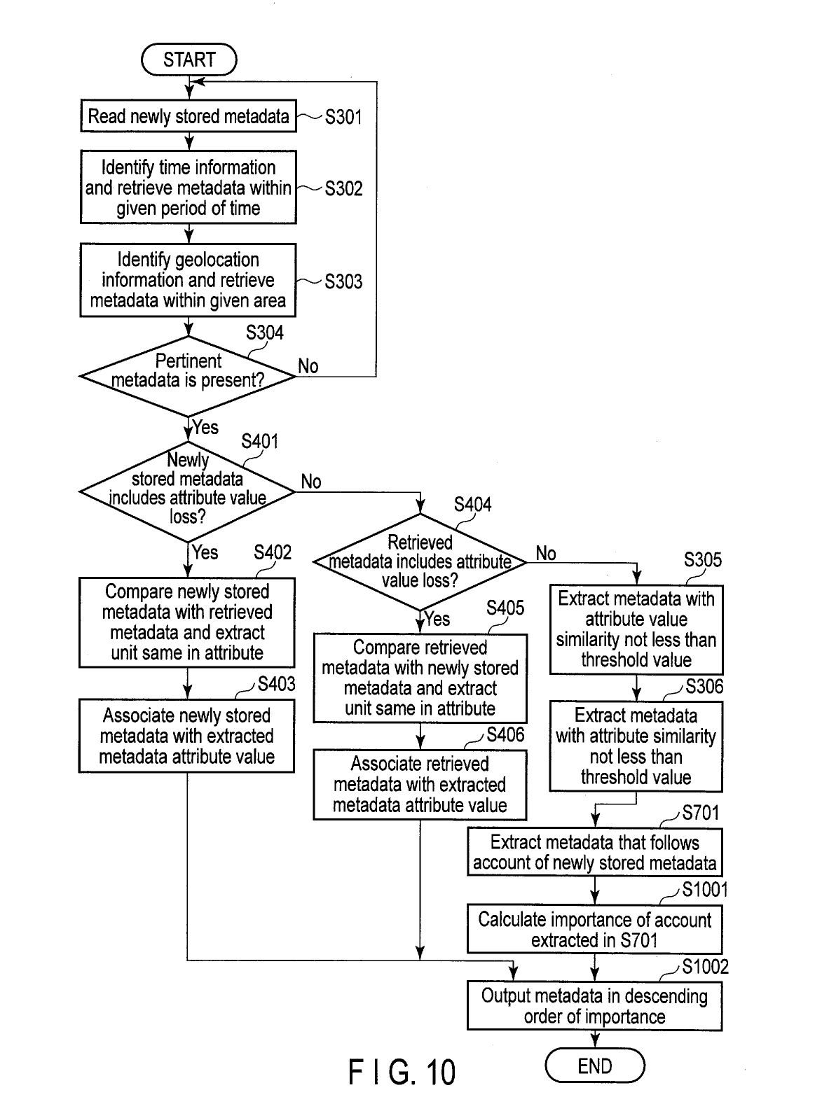

Next, operations performed by the metadata retrieval unit 104 and the importance calculation unit 902 according to the third embodiment are explained with reference to the flow chart shown in FIG. 10.

The processes in the steps of from S301 to S307, the processes in the steps of from S401 to S406, and the process in the step S701 are the same as those described above, and so their descriptions are omitted here.

In step S1001, in relation to the metadata extracted in the step S701, the importance calculation unit 902 calculates the total number of other account IDs that follow the account ID of this metadata, and determines the importance of this account ID. The importance may be determined such that the importance is set higher with an increase in the total number thus calculated, or such that the importance is set by use of weighting with information from metadata constructed in advance to correlate the respective account IDs with ages, regions, and/or the like.

In step S1002, the metadata retrieval unit 104 outputs pieces of metadata thus corresponding in the descending order of the level of importance. For example, it may output the top three pieces of metadata with a higher level of importance. Alternatively, it may output all of the pieces of corresponding metadata that the importance is calculated.

According to the third embodiment described above, it is possible to extract the metadata of information sources with higher reliability by calculating the importance based on the follow relationships.

The flow charts of the embodiments illustrate methods and systems according to the embodiments. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a collection unit configured to collect pieces of first metadata from a plurality of information sources, each piece of first metadata relating to information that has no common standard of data model to be exchanged between the plurality of information sources and including first attributes and first attribute values, the first attributes indicating item names included in the piece of first metadata, the first attribute values corresponding to the first attributes;
a storage configured to store each of the first attributes and first attribute values corresponding to each of the pieces of first metadata; and
a retrieval unit configured to newly obtain a piece of second metadata including second attributes and second attribute values, and retrieve the pieces of first metadata, based on corresponding relations of the first attributes and the first attribute values with the second attributes and the second attribute values, to extract corresponding metadata that is one of the pieces of first metadata and corresponds to the piece of second metadata, the second attributes indicating item names in the piece of second metadata, the second attribute values corresponding to the second attributes.

2. The apparatus according to claim 1, wherein the first attributes include an identifier of an information source, geolocation information of the information source, and time information when the information is generated by the information source, and
the retrieval unit extracts the corresponding metadata based on at least one of a determination of whether or not a similarity between the second attributes and the first attributes is not less than a threshold value, and a determination of whether or not a similarity between the second attribute values and the first attribute values is not less than the threshold value.

3. The apparatus according to claim 1, wherein the first attributes include an identifier of an information source, geolocation information of the information source, and time information when the information is generated by the information source, and
the retrieval unit extracts, as the corresponding metadata, one of the pieces of first metadata that includes first attributes and first attribute values similar to the second attributes and the second attribute values respectively, by referencing a thesaurus.

4. The apparatus according to claim 1, wherein if at least part of the second attribute values corresponding to the second attributes is lost, the retrieval unit extracts, as the corresponding metadata, one of the pieces of first metadata that includes first attributes with a similarity not less than a threshold value relative to the second attributes,
if at least part of the first attribute values corresponding to the first attributes is lost, the retrieval unit extracts, as the corresponding metadata, the piece of second metadata that includes second attributes with the similarity not less than the threshold value relative to the first attributes.

5. The apparatus according to claim 1, wherein if the plurality of information sources each include identifier to utilize a common system, the retrieval unit preferentially extracts, as the corresponding metadata, one of the pieces of first metadata of an information source that includes a follow relationship with an information source generating the piece of second metadata, the follow relationship representing relationships between the identifiers corresponding to the plurality of information sources.

6. The apparatus according to claim 5, wherein the retrieval unit sets an importance of the corresponding metadata which is transmitted from one of the plurality of information source, to be higher as the number of people interested in the one of plurality of information source is larger, by referencing the follow relationship.

7. The apparatus according to claim 1, wherein if one of the plurality of information sources is relevant to a general user, the collection unit collects geolocation information of the one of the plurality of information source from a geographical name included in a text created by the general user.

8. The apparatus according to claim 1, wherein the plurality of information sources include at least one of a fixed point camera installed at a commercial facility or road to obtain a moving image or still image, a microphone installed at a shelter facility to obtain an audio signal, disaster information and weather information which are announced from a municipality or mass media, and disaster information transmitted from a general user.

9. An information processing method, comprising:
collecting pieces of first metadata from a plurality of information sources, each piece of first metadata relating to information that has no common standard of data model to be exchanged between the plurality of information sources and including first attributes and first attribute values, the first attributes indicating item names included in the piece of first metadata, the first attribute values corresponding to the first attributes;
storing, in a storage, each of the first attributes and first attribute values corresponding to each of the pieces of first metadata; and
newly obtaining a piece of second metadata including second attributes and second attribute values, and retrieving the pieces of first metadata, based on corresponding relations of the first attributes and the first attribute values with the second attributes and the second attribute values, to extract corresponding metadata that is one of the pieces of first metadata and corresponds to the piece of second metadata, the second attributes indicating item names in the piece of second metadata, the second attribute values corresponding to the second attributes.

10. The method according to claim 9, wherein the first attributes include an identifier of an information source, geolocation information of the information source, and time information when the information is generated by the information source, and
the retrieving the pieces of first metadata extracts the corresponding metadata based on at least one of a determination of whether or not a similarity between the second attributes and the first attributes is not less than a threshold value, and a determination of whether or not a similarity between the second attribute values and the first attribute values is not less than the threshold value.

11. The method according to claim 9, wherein the first attributes include an identifier of an information source, geolocation information of the information source, and time information when the information is generated by the information source, and
the retrieving the pieces of first metadata extracts, as the corresponding metadata, one of the pieces of first metadata that includes first attributes and first attribute values similar to the second attributes and the second attribute values respectively, by referencing a thesaurus.

12. The method according to claim 9, wherein if at least part of the second attribute values corresponding to the second attributes is lost, the retrieving the pieces of first metadata extracts, as the corresponding metadata, one of the pieces of first metadata that includes first attributes with a similarity not less than a threshold value relative to the second attributes,
if at least part of the first attribute values corresponding to the first attributes is lost, the retrieving the pieces of first metadata extracts, as the corresponding metadata, the piece of second metadata that includes second attributes with the similarity not less than the threshold value relative to the first attributes.

13. The method according to claim 9, wherein if the plurality of information sources each include identifier to utilize a common system, the retrieving the pieces of first metadata preferentially extracts, as the corresponding metadata, one of the pieces of first metadata of an information source that includes a follow relationship with an information source generating the piece of second metadata, the follow relationship representing relationships between the identifiers corresponding to the plurality of information sources.

14. The method according to claim 13, wherein the retrieving the pieces of first metadata sets an importance of the corresponding metadata which is transmitted from one of the plurality of information source, to be higher as the number of people interested in the one of plurality of information source is larger, by referencing the follow relationship.

15. The method according to claim 9, wherein if one of the plurality of information sources is relevant to a general user, the collecting pieces of first metadata collects geolocation information of the one of the plurality of information source from a geographical name included in a text created by the general user.

16. The method according to claim 9, wherein the plurality of information sources include at least one of a fixed point camera installed at a commercial facility or road to obtain a moving image or still image, a microphone installed at a shelter facility to obtain an audio signal, disaster information and weather information which are announced from a municipality or mass media, and disaster information transmitted from a general user.

17. A non-transitory computer readable medium including computer executable instructions, wherein the instructions, when executed by a processor, cause the processor to perform a method comprising:
collecting pieces of first metadata from a plurality of information sources, each piece of first metadata relating to information that has no common standard of data model to be exchanged between the plurality of information sources and including first attributes and first attribute values, the first attributes indicating item names included in the piece of first metadata, the first attribute values corresponding to the first attributes;
storing, in a storage, each of the first attributes and first attribute values corresponding to each of the pieces of first metadata; and
newly obtaining a piece of second metadata including second attributes and second attribute values, and retrieving the pieces of first metadata, based on corresponding relations of the first attributes and the first attribute values with the second attributes and the second attribute values, to extract corresponding metadata that is one of the pieces of first metadata and corresponds to the piece of second metadata, the second attributes indicating item names in the piece of second metadata, the second attribute values corresponding to the second attributes.
